(19) United States
(12) Patent Application Publication
(10) Pub. No.: US 2011/0187984 A1
(43) Pub. Date: Aug. 4, 2011

(54) METHOD FOR REGENERATING THE LIQUID CRYSTALS OF VARIABLE LIGHT-SCATTERING ELECTRICALLY CONTROLLED SYSTEMS, ELECTRICAL POWER SUPPLY AND DEVICE FOR SAID REGENERATION

(75) Inventors: Philippe Letocart, Raeren (BE); Annabelle Andreau-Wiedenmaier, Aachen (DE)

(73) Assignee: Saint-Gobain Glass France, Courbevoie (FR)

(21) Appl. No.: 13/002,433

(22) PCT Filed: Jul. 2, 2009
(86) PCT No.: PCT/FR2009/051286

§ 371 Date: Mar. 30, 2011

(30) Foreign Application Priority Data
Jul. 4, 2008 (FR) 0854587

(51) Int. Cl. G02F 1/13

(52) U.S. Cl. 349/187

(57) ABSTRACT

A method for regenerating liquid crystals of a variable light-scattering electrically controlled system including a substrate carrying a liquid crystal element between two electrodes connected to an electrical power supply, the method including: supplying data for the regeneration comprising a regeneration duration DT and at least one regeneration setpoint C, programming for the regeneration comprising comparing operational data with the regeneration setpoint C, automatically regenerating by automatic power-down of the electrical circuit for the period of the duration DT, once the setpoint or setpoints C have been reached, and programming for an operating decision referred to as ‘forced mode’ during the regeneration in progress depending on the history of use and/or the context of use.

The subject of the invention is a method for regeneration of liquid crystals for variable light-scattering electrically controlled system(s) comprising a substrate carrying a liquid crystal element between two electrodes connected to an electrical power supply together with said power supply and the regeneration device.

There is currently an increasing demand for window panes known as “smart windows” whose properties can be modulated. In particular, it is desired to control the degree of transparency through the windows, notably to reduce it or even completely block it for a certain period of time.

A window pane with variable light-scattering properties, whose principle of operation is well known, is a liquid crystal window pane. It is based on the use of a film placed between two conducting layers and which is made of a polymer material within which droplets of liquid crystal are dispersed, notably those in the nematic phase with positive dielectric anisotropy. When a voltage is applied to the film, the liquid crystals align themselves along a preferred axis which allows transparency. When the voltage is removed, in the absence of alignment of the crystals, the film becomes light-scattering and impedes transparency. Examples of such films are notably described in the European patents EP0238164 and U.S. Pat. No. 4,435,047, U.S. Pat. No. 4,806,922 and U.S. Pat. No. 4,732,456. Once laminated and incorporated between two substrates, this type of film is marketed by the company SAINT-GOBAIN GLASS under the commercial name of Privalite.

These window panes are used intensively and it is crucial to guarantee the long-term operation.

Accordingly, for this purpose, the present invention provides a method for regenerating liquid crystals of a variable light-scattering electrically controlled system comprising a substrate, notably transparent, carrying a liquid crystal element between two electrodes connected to an electrical power supply, this method comprising:
the supply of data for the regeneration comprising a regeneration duration DT and at least one regeneration setpoint C,
programming comprising the comparison of operational data with the regeneration setpoint C,
the automatic regeneration by automatic power-down of the electrical circuit for the period of the duration DT, once the setpoint or setpoints C have been reached,
and programming for an operating decision referred to as ‘forced mode’ during the regeneration in progress depending on the history of use and/or the context of use.

Beyond the automatic programming of the regeneration, ensuring the sustainability of the system in a simple and reliable manner, the regeneration method according to the invention also offers smart management of the regeneration, allowing the requirements to be better targeted.

It is thus possible to interrupt the regeneration if necessary while at the same time limiting the risks of damaging the liquid crystals.

The operational data, useful for regeneration, are of several types:
temporal data: the duration of prolonged use(s), local time,
“contextual” data reflecting the context of use, notably the light intensity level, etc.

As data on the context of use, useful for the decision on forced mode, the following may be mentioned:
the number, frequency and period(s) of use of forced mode, starting from the installation of the electrically controlled system or on the latest period of use (for example the last three months, etc.),
the (latest) periods of use (cumulated) without regeneration,
the current duration DT1 of the regeneration in progress.

For example, the regeneration may be cancelled if the duration DT1 is equal to or exceeds 0.50 DT or possibly 0.75 DT.

In order to guide the decision, the request for forced mode may of course include an estimated period of use DTu in forced mode.

For example, the regeneration may be cancelled if the sum of the latest period of use and of the estimated, period of use in forced mode DTu is less than a limiting value DT₁, a value which is generally greater than DT.

Furthermore, enabling a limited forced mode may be included, for example by reducing the desired duration DTu to an acceptable duration DT2.

The use of forced mode can preferably (automatically) result in a new setpoint, typically a new triggering of a regeneration as soon as possible, and can even result in a new DT which may be longer or, depending on the case, shorter.

The regeneration can preferably be triggered as soon as the validated forced mode period (DT2 or DTu) has ended.

The new setpoint can replace at least once the initial setpoint. The initial setpoint can be kept for the next regeneration(s).

Preferably, reducing the regeneration period, DT, in other words exceeding the maximum period of continuous use DT′, should be avoided.

As data on the context of use, useful for the decision on forced mode, the data coming from sensors may be mentioned: detection of light and/or presence and/or movement.

For example, forced mode may be refused:
when the lighting of the room is low or even dark, thus rendering the use of the smart window redundant,
when the frequency of actuation of the switch is equal to or greater than a certain value, for example 1/10 Hz, or possibly 1 Hz, indicating an operating error or a problem with the switch,
when the regeneration period in progress is defined as highest priority and fixed, for example a usual, predefined, period when the system is not used (at night, etc.).
   Conversely, forced mode can be enabled:
in an emergency or in case of urgent need, for example in a medical environment, notably in operating theaters,
and/or depending on data (requested, received, where possible stored, etc.) on the person requesting forced mode (for example, his position: surgeon, manager, and/or his identity, etc.),
and/or unplanned circumstances, notably in the case of last-minute reservation of the premises with the electrically controlled system, in the case of a failure of the server for reservation of the premises with the electrically controlled system.

A systematic forced mode may furthermore be provided (without the need for permission), in other words a forced mode command, for example for particular circumstances: emergency or backup regeneration, notably in the case of a fault in the programming of forced mode.

Modification of the duration of forced mode may also be provided, for a reduction or an increase in the duration envisioned DTu and/or validated DT2.

The triggering of the interruption can be immediate (as soon as the setpoint(s) is/are reached or, where provided, differed).

The interruption of the circuit can, for example, be by the opening of a relay, for example, electromechanical (of the solenoid type) or electronic (of the solid-state type).

In a first embodiment, the interruption is on the electronic circuit external to the power supply housing, by “external” means added for this purpose between the housing of the power supply and the line supply, typically an external relay.

Programming for the regeneration can also be external by means added for this purpose between the housing of the power supply and the line supply, for example by means of a programmable clock or programmable connector associated with an external relay.

In a second embodiment, the interruption is on the electronic circuit inside the power supply housing, typically by an internal relay.

Furthermore, the value of the setpoint C and/or of the duration DT can be received by the power supply or stored or even calculated by the electrical power supply.

The programming for the regeneration can be (at least in part) local, for example by simply adding “external” means between the line supply and the housing of the power supply or by “internal” means within the power supply housing.

The electrical power supply can be completely autonomous in its management of the regeneration. It preferably comprises a digital processing unit (microprocessor, etc.), which calculates or uses the setpoint C and the (minimum) regeneration period DT and performs said comparison with the operational data.

One or more data values for the regeneration may be fixed, for example written during a reset or update operation. For example, the aging of the liquid crystals may be taken into account or even, in the case of maintenance, the installation of a new liquid crystal element notably of another type.

At least one of the data values for the regeneration can be sent, notably updated, via a communications network.

The local programming can also be upgraded and updated via a communications network.

The programming for the regeneration may (at least in part) be delocalized, remote from the electrically-controllable system or even from the location of the system.

The electrical power supply can therefore collect and send via a communications network information required for remote (at least in part) programming. It sends for example information for a new setpoint and/or new regeneration period in the case of exchange of a liquid crystal element, or for a simple update of C or of DT.

Even in the case of local programming, a command for interruption of the regeneration can be sent via a communication network, the power supply then simply processing this command.

The management of the communication between the electrical power supply and a communications server may be defined on a temporal basis, in the case for example of a regular interrogation, notably daily, of the server and/or on a contextual basis, in the case of a fault for example.

A regular interrogation, of frequency chosen depending on the regeneration cycle, for example daily, of the server may thus be provided in order to check whether the (latest) regeneration programmed has been carried out and to order an backup regeneration, if necessary.

Thus, for greater flexibility and interactivity (hence smart management), the regeneration method preferably relies on a communications network.

The method can therefore provide the connection of the electrical power supply to a communications network:
for receiving the data for the regeneration to be carried out, and/or for directly receiving the interrupt command, as already indicated,
and/or for the transmission of data on the regeneration carried out, temporal and/or contextual data, preferably stored permanently in the power supply, and readable by a connected computer (PC of a repair technician, etc.) or by a server.

The connection may be temporary or, preferably, continuous for transmission of data in real time. The communications network can preferably be bidirectional.

The communications network can more precisely be:
via dedicated wires such as the well-known RS485 networks, LAN local network, CAN, IEB, LonWorks or BACnet networks, for example described on the Internet on Wikipedia,
via radiofrequency,
via power lines,
via infrared,
via optical fibers,
via telephone network, via cellular network or GSM.
   Preferably, a CAN network is used for cost and performance reasons and in order to allow, when necessary, the smart regeneration of a plurality of electrically controlled liquid crystals systems to be readily managed.

Each CAN bus implements a protocol of the same name (CAN protocol) which is a serial communications protocol that supports real-time systems with a high level of reliability in a limited and severe environment such as a factory, a workshop, an automobile, etc.

The CAN protocol covers two of the seven layers of the interconnection model of the ISO OSI open systems, namely the physical layer (layer 1) and the data-link layer (layer 2). For more information on the CAN bus, reference could be made to the ISO 11898 standard, included here as a reference.

The data-link layer of the CAN protocol is such that each control unit can emit and receive data. The data are transported over the bus in the form of asynchronous packets (also called frames or messages) with a defined format but of variable and limited length. As soon as the bus is free, any control unit connected to the bus can emit a new packet. An interruption mechanism for the higher priority packets is provided, together with a mechanism for resolving the conflicts resulting from the simultaneous emission of several packets over the bus when it is free.

In the same way, as far as the programming for forced mode is concerned, this may be:
local and, even more preferably, (at least in part) internal to the power supply,
and/or delocalized, remote from the electrically-controllable system or even from the location of the system.

The electrical power supply can notably simply act on the order to operate in forced mode, for example transmitted by a communications network, notably that already described.

The method can thus comprise the transmission of a request for forced mode via a communications network and/or via direct connection (electrical) with the electrical power supply notably with internal local programming for forced mode and for regeneration.

Furthermore, a forced mode can be applied for a regeneration period DT by one of the following operations:
upon request of the user, typically by manual triggering: closing a switch, directly connected to the power supply, or connected to a communications network,
and/or using information from sensors: detection of presence, of access to the location of the system, from badge reader, etc.

The user may therefore be the (only) requestor for forced mode or forced mode may, cumulatively or alternatively, be remotely controlled and managed via communications network. The method then includes the connection of the electrical power supply to a communications network for forced mode command.

In particular, the transmission of a request for forced mode and/or the transmission of a command for forced mode (and/or the power up of the system, in other words normal operation) by actuation of a switch or switches connected to a communications network, typically via digital processing means with network interface.

A switch can also be provided (for example considered as main switch) for requesting forced mode (and/or normal operation) and another switch (for example considered as backup) for a forced mode command.

The user can consciously generate a request for forced mode, when for example the method includes an (automatic) indication of the state of the system, for example audible and/or visual indication of the section of regeneration in progress.

The user can also generate a request for forced mode inadvertently, not having been informed of the regeneration in progress.

In particular, controlling forced mode by manual command can be provided (actuation of a switch referred to as emergency switch, of a push button referred to as emergency button) and/or by automatic closing of a relay connected to the power supply (typically a relay external to the power supply housing) and controlled by the digital processing means connected to the communications network.

The regeneration period DT and/or the interrupt setpoint C vary notably according to the type of liquid crystals.

For conventional liquid crystal films, a duration DT of a few hours, for example 4 hours, is reasonable for a maximum operating period DT′ of 20 hrs (continuous or in several sections and without prolonged inactive periods).

If necessary, a daily regeneration is preferably provided (in order not to exceed 20 hrs of operation), and preferably only one regeneration daily.

More generally, the setpoint C can be established based on various scenarios.

Thus, the interrupt can be controlled:
(with the highest priority) based on operational temporal data notably a maximum period of use DT′, a starting time or a given regeneration allocated timeslot (for example daily), notably the most probable time(s) and/or period(s) of non-operation,
and/or without necessarily waiting for the maximum period of use DT′ recommended based on the contextual data supplied by a sensor or sensors electrically connected to the electrical power supply or from data supplied by a sensor or sensors and received by the electrical power supply via a communications network.

Several setpoints may be required for the triggering of the regeneration.

The maximum period of use DT′ (in one or several times) can be measured locally by a counter, a clock, notably within the housing of the power supply, and/or by a server (with a counter or a centralized clock) connected at regular intervals or permanently with the electrical power supply via a communications network.

Similarly, the detection of the start time for the regeneration can be carried out by the electrical power supply (by a clock or indirectly by a counter) and/or by information from a server connected at regular intervals or permanently with the electrical power supply via a communications network.

The allocated timeslot can be fixed, written during the reset or update (via a communications network), or reprogrammable as already indicated.

In order to best know the context of use in the case of a regeneration dictated by a sensor or sensors, one or more sensors may be used preferably close to the system or possibly within or on the electrically controlled system.

A light sensor can notably be used. The interrupt is then triggered for a given value of brightness produced by a natural or artificial light.

For example, the regeneration is triggered during the night. Of course, if it is planned to use the system at night, typically in a lit room (room with a projection screen, recreational premises such as a casino, etc.), or in an illuminated location (sports equipment, swimming pool, pontoon for boats, etc.), other regeneration time periods and/or other setpoints are possible.

The interrupt command can be issued in the absence of a detected presence and/or movement.

Thus, a presence sensor (or absence for a sufficiently long period) or a motion sensor can be used, potentially also coupled to the light (artificial or natural) sensor.

An interruption can be planned in the case of the premises (notably an enclosed space) including the electrically controlled system being unoccupied for a sufficiently long period of time.

Any type of sensor generally used for home automation systems may for example by associated: detectors for presence, door opening, motion, room entry, etc.

The interruption can also be planned in the case of inoccupation, or in the case of absence of reservation of the space (closed or open) including the electrically controlled system, notably by consulting a reservation server via a communications network (for example a LAN network, EIB network, etc.) in order to sound out the scheduling.

Typically, a reservation server for meeting rooms, recreational areas, hotel rooms, etc.

Several factors are therefore able to trigger the regeneration (allocated timeslot, night, lack of reservation, etc.). As soon as the regeneration has finished, the programming may include the locking-out or disabling of any possible following interrupt commands that are pointless since they are for example too soon. An order of priority can also be pre-established for the interrupt commands: for example, an interrupt via the network takes priority over a local interrupt, an interrupt from information given by sensor takes priority over an interrupt within a predefined allocated timeslot.

However, the normal regeneration period DT may be lengthened, (by prolonging the automatic interruption for reasons of energy saving, preferably after verification (dialogue via a communications network, etc.)).

The setpoint value C and/or the duration DT can also be adapted as a function of the temperature of operation of the electrically controlled system.

For the calculation of C and DT, tables on C and DT as a function of the temperature of operation, notably in the power supply, can notably be provided stored in memory; the higher the temperature, the shorter the duration DT.

Accordingly, the direct measurement of this temperature or the calculation of this temperature can be included.

A temperature sensor can, for example, be added to the system (within the system or on the substrate), the sensor being connected to the electrical power supply and/or to a communications network.

The operating temperature of the system may also be deduced by measurement of the electrical resistance of one of the electrodes.

Furthermore, the method can comprise the storage of the data for the regeneration to be carried out and/or on the regeneration carried out and, where relevant, on forced mode, notably the storage:
of duration(s) and date(s) of the regenerations over a given past period, for a verification, for detecting a programming error,
of effective duration of normal operation,
of duration(s) and date(s) of forced modes over a given past period, notably for detecting an error in management of forced mode,
of setpoint data C or for the setpoint C and/or duration DT: reservation planning information, information on the type of liquid crystals, dependence on temperature.

Preferably, the storage is within the housing of the electrical power supply, and even more preferably in a microcontroller, and is permanent. The memory can however be resettable.

The invention also relates to a regeneration method for liquid crystals of a plurality of variable light-scattering electrically controlled systems, each comprising a substrate carrying a liquid crystal element between two electrodes connected to an electrical power supply, the method incorporating the regeneration method such as previously defined which includes, for each of the power supplies:
the establishment of data for the regeneration comprising a regeneration period DT and at least a regeneration setpoint C,
programming for the regeneration comprising the comparison of operational data with the regeneration setpoint C,
the automatic regeneration by automatic interruption of the electrical circuit during the period DT, once the setpoint or setpoints C have been reached,
and programming for a decision on a mode of operation referred to as ‘forced mode’ during the regeneration in progress depending on the history of use and/or the context of use.
and the method comprises, for the communication of data for the regeneration or regenerations to be carried out and/or on the regeneration or regenerations carried but, the connection of the electrical power supplies to the same communications network.

Of course, the setpoint and/or the regeneration period can be:
individual (in other words element by element),
or collective: by group of systems, by type of system (liquid crystal film or other liquid crystal elements, by localization (external systems, internal systems, etc.), by system functionality (partition, projection screen, etc.).

The triggering of a collective regeneration can be using a common command signal (sharing) transmitted via a bidirectional communications network and processed by the power supplies.

Preferably, the addressing of the power supplies (individual addressing, by group, etc.) is configured for targeting the recipients and/or the emitters of the data.

In addition, the following may be included:
sharing of the regeneration programming and/or for forced mode, by one or more external programming centers,
the sharing of sensor(s), of information on the sensors,
the sharing of information for the regeneration to be carried out or forced mode.

Lastly, the invention relates to an electrical power supply of a variable light-scattering electrically controlled system having a substrate carrying a liquid crystal element between first and second electrodes comprising, for the implementation of the regeneration method previously defined:
a first (digital) processing unit for the programming, the unit being capable of receiving or calculating the setpoint C and the regeneration period DT,
a processing unit for the programming of forced mode, the unit being capable of receiving a request for forced mode, or else a forced mode command,
a relay (internal, within the power supply housing) or a connection to a relay (external to the power supply housing), for the interruption of regeneration and for forced mode.

Preferably, a single processing unit is used for the programming operations, which is furthermore preferably within the power supply housing.

In a preferred manner, the power supply comprises a microcontroller (preferably internal, within the power supply housing) comprising:
a microprocessor forming the processing unit for the regeneration programming operations and for forced mode,
a counter or a clock, for the establishment and/or the compliance with the setpoint C and/or the duration DT and/or for the recording of data on the regeneration carried out,
preferably a non-volatile memory for storage of the setpoint C and/or the duration DT, and/or of data on the regeneration carried out,
at least one digital-analog output delivering an analog interrupt signal for the regeneration or a signal for implementing forced mode during the regeneration (or even normal operation).

The microcontroller can also comprise at least one analog-digital input and be connected (electrically) to a sensor, preferably a light sensor (phototransistor, photovoltaic cell, etc.) or temperature sensor, transmitting data as already indicated.

The sensor may be in the system, at the location of the system, or else remote, connected to the communications network.

The microcontroller may be replaced by discrete digital and/or analog elements.

The electrical power supply may also comprise:
an interface with a communications network, preferably bidirectional, serial, notably a CAN,
an indicator for the regeneration and for forced mode, for example:
a lamp of the red LED diode type (regeneration mode), or green (forced or normal),
a digital display screen,
an audible signal, etc.

The invention also relates to a device for the regeneration of liquid crystals of at least one variable light-scattering electrically controlled system equipped with a substrate carrying a liquid crystal element between first and second electrodes, the device comprising:
at least one electrical power supply as previously defined connected to a communications network,
at least one switch, called main switch, potentially connected to the communications network via a processing unit, notably digital, of the microcontroller type, and operable by the user for normal operation or a request for forced mode in the case of interruption of the regeneration,
preferably, at least one other switch called emergency switch connected to the communications network via a processing unit, notably of the microcontroller type, and operable by the user for a forced mode command in the case of interruption of the regeneration,
optionally a relay, called backup relay, controlled by a processing unit connected to the communications network, for a forced mode command in the case of interruption of the regeneration.

The invention can thus employ a communications network, notably bidirectional such as those already described, in order to manage the regeneration of liquid crystals of a number N greater than or equal to 1 of variable-scattering electrically controlled systems.

Electrically controlled systems can thus be managed in one or more buildings, in a house, a room, or else in a terrestrial, airborne or sea-going vehicle.

The main switch may be dedicated to a single power supply, or to a group of power supplies (common management of the request for forced mode and/or for normal operation). For one electrically-controllable system, the normal mode of operation could for example be engaged and for another electrically-controllable system, a forced mode could be requested during the regeneration.

The emergency switch may be dedicated to a single power supply, or at least to a group of power supplies (common management of forced mode command), for example in order to control a defined group of electrically controlled systems (in the same location, and/or in the same context of use, etc.).

The device for the regeneration may include at least one sensor, notably a light sensor and/or a presence sensor and/or a temperature sensor, electrically connected to the electrical power supply, for example via an analog-digital input of a microcontroller.

The device may include (for each power supply), an indicator for the regeneration and/or for forced mode, for example via an analog-digital input of a microcontroller. The device may include at least one sensor, notably a light sensor and/or a presence sensor and/or a temperature sensor connected to the communications network via a processing unit, where the sensor or the sensors may be common to several power supplies.

The device may include (for each power supply), an indicator for the regeneration and/or for forced mode, connected to the communications network via a processing unit.

Several types of liquid crystal elements can be regenerated.

Any of the liquid crystal elements known under the terms of “NCAP” (Nematic Curvilinearly Aligned Phases) or “PDLL” (Polymer Dispersed Liquid Cristal) or “CLC” (Cholesteric Liquid Cristal) may in fact be used.

These can furthermore contain dichroic colorants, notably in solution within the droplets of liquid crystals. Then, the light-scattering and the light absorption of the systems may be jointly modified.

Cholesterolic liquid crystal based gels containing a small amount of reticulated polymer such as those described in the patent WO92/19695 may, for example, also be used.

The elements more usually take the form of a polymer film, the polymer containing droplets containing liquid crystals. In order to provide its supply of electrical power, it is usually disposed between two electrically-conducting, notably transparent, layers.

In addition, the polymer film with its two conducting layers usually has, on at least one of its faces, and preferably on both of them, a carrier substrate. The latter is generally transparent. It can be chosen to be rigid or semi-rigid, for example made of glass, acrylic polymer of the polymethyl methacrylate PMMA type or polycarbonate PC. It can also be flexible, notably made of polyethylene terephtalate PET or made from certain flexible polycarbonates.

The structure can, thus be of the type PET/electrically-conducting layer of the ITO type/polymer/electrically-conducting layer the ITO type/PET, which takes the form of an easily-manipulated flexible sheet. This assembly (polymer+electrically-conducting layers+at least one carrier substrate) can then be laminated to at least one transparent rigid substrate of the glass type by means of at least one layer of bonding organic polymer of the type polyvinylbutyral PVB, ethylenevinylacetate EVA or certain polyurethanes PU.

Accordingly, preferably, the electrically controlled liquid crystal window pane is a laminated panel comprising a first rigid substrate, notably a window pane, a second substrate, notably a counter-window pane, and the active system between two lamination spacers (layer of bonding organic polymer of the PVB, EVA or PU type).

Any other adhesive means between the two substrates to be assembled may be provided, notably a glue or a pressure adhesive of the acrylate derivatives type.

Furthermore, the system according to the invention previously described may be advantageously assembled as a single-window pane (nevertheless laminated) and/or as a multiple-glazing with gas-layer spacer gaps.

These Privalite window panes are used as internal partitions between two rooms, in a building, or between two compartments within a means of locomotion of the train or airplane type.

Many other applications also exist for such window panes: for example, the following may be mentioned: rear-view mirrors for vehicles, which, by darkening when necessary can avoid the driver being dazzled, or road or urban warning signs, which only show messages or images intermittently in order to better catch the attention of the observer. Mention may also be made of transparent window panes whose surface state is sufficiently scattering to be used as projection screens.

The electrically-controllable system can also be used:
in a wet room (separate or forming a part of a bedroom or any other room), a wash room or laundry room, in a bathroom, a shower, such as a shower cubicle, notably as flooring, a wall, partition, door (possibly sliding), exterior or interior window,
in a swimming pool, as a base floor unit, side wall of a swimming pool, window for a swimming pool,
in a façade of building (display window, window notably on the ground or garden floor),
in a boat.

The invention will now be described in more detail with regard to the appended drawings in which:

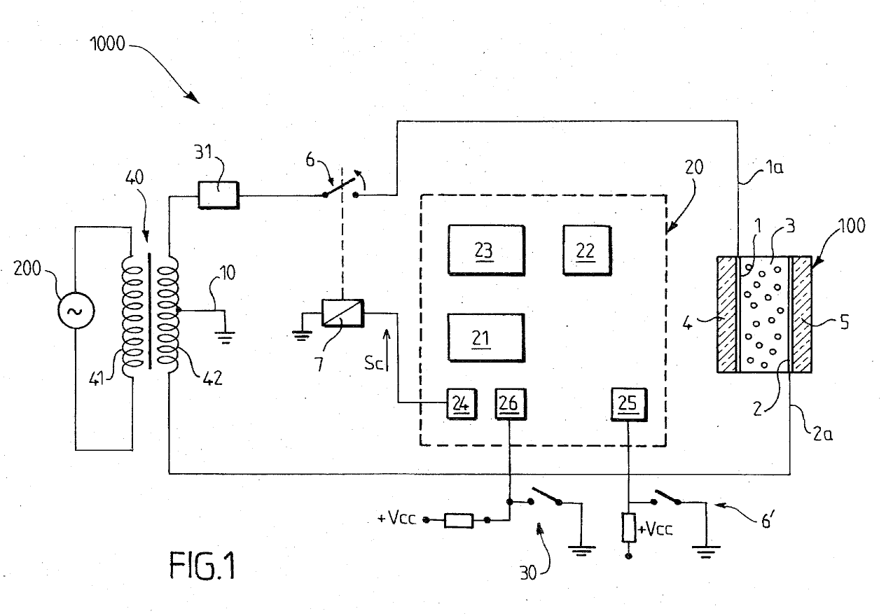

FIG. 1 shows a diagram of a device for the regeneration of the liquid crystals of a variable light-scattering electrically-controllable system in a first embodiment of the invention,

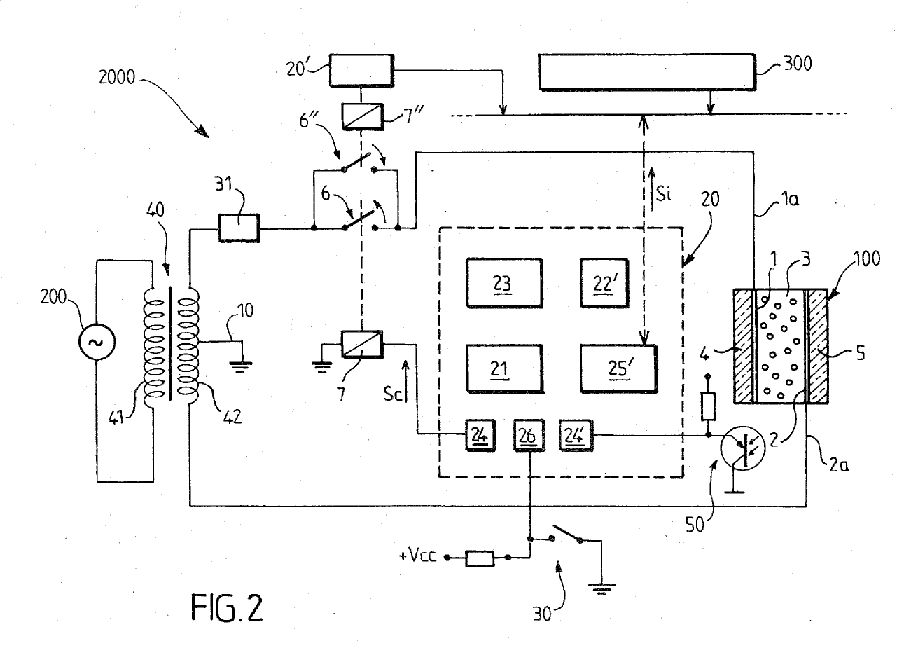

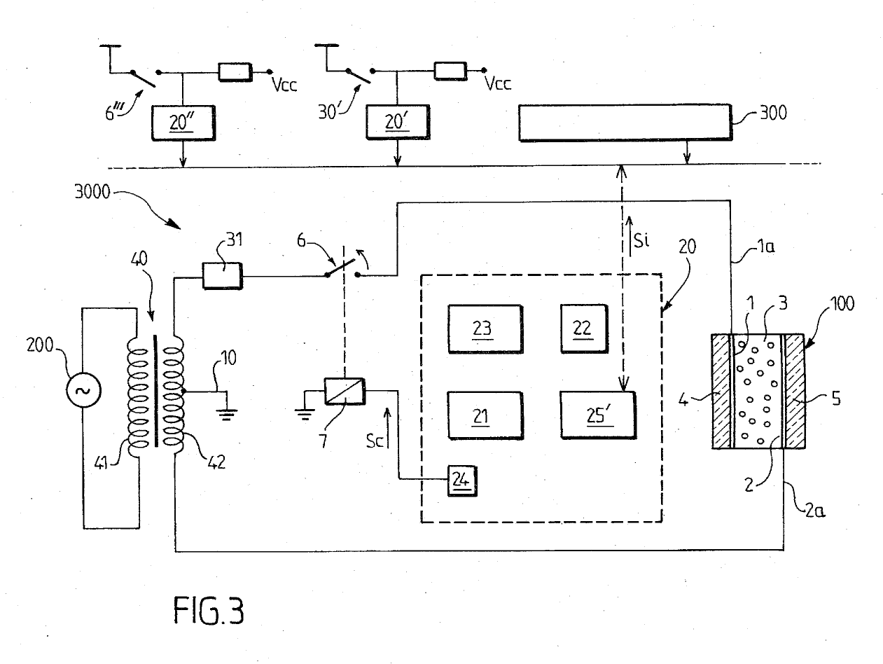

FIG. 2 shows a diagram of a device for the regeneration of the liquid crystals of a variable light-scattering electrically-controllable system in a second embodiment of the invention, FIG. 3 shows a diagram of a device for the regeneration of the liquid crystals of a variable light-scattering electrically-controllable system in a third embodiment of the invention.

### EXAMPLE OF LIQUID CRYSTAL WINDOW PANE

First of all, the structure of a Privalite panel is recalled:

Glass/EVA/PET/ITO/liquid crystal emulsion/ITO/PET/EVA/Glass.

For the two substrates, 4 mm clear calcium-sodium silicate glass is for example chosen, or it can even be tinted in the bulk and/or have different thicknesses, for example in the range between 3 and 6 mm.

More precisely, the active system is composed of a transparent polymer film, in which microdroplets of a nematic liquid crystal have been previously dispersed, which forms the emulsion of liquid crystals with a total thickness of 25 μm, and which is sandwiched between the two sheets of polyethylene terephtalate (PET) of 175 μm in thickness each coated with a transparent conducting layer of ITO with a resistance per square equal to 75 Ohms per square.

The molecules of liquid crystal have several refractive indices: two equal indices no in the two directions perpendicular to their axis of symmetry and one index ne in the axis of symmetry. The polymer is chosen so as to have a refractive index very close to the ordinary index no. In the absence of voltage, the axes of the various droplets are not correlated with one another. The incident light therefore undergoes, at each polymer-droplet interface, a strong refraction due to the difference in index between the polymer and the droplet whose orientation is random. The light is therefore scattered in all directions.

Under maximum voltage Uo, the optical axes of the various droplets align themselves in the direction of the electric field, this being perpendicular to the window pane. The incident light, essentially normal to the window pane, now only sees a medium of continuous index np equal to no and is no longer scattered.

The intermediate states of blurring are accessible at the desired speed with voltage values included notably in the range between 0 and Uo. For this purpose, a voltage variator (or “dimmer”) is used.

### Example No 1

FIG. 1 illustrates a device 1000 for the regeneration of liquid crystals of a variable light-scattering window pane of the Privalite 100 type such as detailed hereinabove (liquid crystal film 3 between two window panes 4, 5 fitted with electrodes 1, 2) in a first embodiment of the invention.

This device 1000 comprises an electrical power supply capable of supplying the window pane with electrical energy and also contributing to the regeneration of the liquid crystals.

For the regeneration of the liquid crystals, the power supply comprises:
a microcontroller 20 (MCU pour “Micro Controller Unit”), for example the Mitsubishi M16C),
and a first relay formed from a solenoid 6 and of a contactor 7 with opening and closing controlled by the microcontroller 20.

Preferably, the microcontroller 20 and the relay 6, are within a power supply housing (not shown). The first relay 6, 7 is connected to the input terminal 1a of the first electrode 1. In one variant, the relay is external to the housing.

More precisely, the microcontroller 20 contains:
a microprocessor 21, for the programming of the regeneration, once the setpoint C has been reached, for example 20 hrs of total use, and for controlling the duration of the regeneration DT, typically 4 hrs,
a counter 22, for calculating the hours of operation and/or complying with the setpoint C and/or the duration DT,
a non-volatile data memory 23, typically a memory of the FLASH type, for the storage of data for the regeneration to be carried out: (DT, setpoint C, etc.), and on the regeneration(s) carried out,
a digital-analog output 24,
an address (not shown).

The microprocessor 21 consults the memory 23 in order to know the setpoint C and the duration DT and consults, as often as necessary, the counter 22 for example in order to determine the moment of the interruption of regeneration. It compares the value “hour” given by the counter timing setpoint C.

Once the setpoint C has been reached, the microprocessor 21 sends a command to the output 24 to deliver an analog control signal Sc for the actuator, triggering the opening of the contactor 7 (as shown by the counter-clockwise arrow) lasting for the period DT.

The counter 22 is also used for recording the effective regeneration duration engaged, and for indicating the end of the regeneration.

A main switch 30, activatable by the user, is connected to the microcontroller 20. This could, for example, be an electronic switch 30 connected to a digitized input 26 of the microcontroller 20.

By closing the main switch 30, depending on the case, the user sends a request for normal operation or a request for forced mode if a regeneration is in progress; this request is processed by the microcontroller 20, 21.

The microcontroller 20, 21 (generally) accepts the request for normal operation (except in the case of electrical incidents) in which case the relay 6, 7 is in the on position (current flowing).

The microcontroller 20, 21 evaluates the forced mode request and, where accepted, it interrupts the regeneration by activating the relay which is in the on position (current flowing).

An emergency switch 6′, activatable by the user, is also connected to the microcontroller 20. This could for example be an electronic switch connected to a digitized input 25 of the microcontroller 20.

By closing the emergency switch 6′, the user sends a forced mode command if a regeneration is in progress, this command is received and accepted by the microcontroller 20. The microcontroller 20 which interrupts the regeneration by sending a command to the relay is in the on position (current flowing).

The regeneration in progress can be indicated to the user by means of a diode (red for example), or of a display, or of a loud speaker, connected to an additional digital-analog output of the microcontroller (elements not shown).

Forced mode in progress can be indicated to the user by means of a diode (red for example), or of a display, or of a loud speaker connected to an additional input of the microcontroller (not shown).

The use of forced mode can preferably lead to a new setpoint with potentially a new regeneration period calculated by the microprocessor 21. The new setpoint replaces at least once the initial setpoint. The initial setpoint can be preserved for future regenerations.

The system may allow the user to set a period of use DTu for forced mode.

The counter 22 is also used to count the duration of forced mode. The memory 23 also stores the temporal and contextual data relating to the use of forced mode.

For the supply of energy, the power supply is connected to the line supply 200 delivering a voltage of 220V (or 110V) at 50 Hz (or 60 Hz). A transformer 40 has a primary winding 41 connected to the line supply 200 and a secondary winding 42 connected to the input terminals 1a and output terminals 2a of the system via a fuse 31 and the actuator 6 already detailed.

The secondary winding 42 allows, where necessary, the (maximum) rms voltage to be delivered to the system 100 to be reduced and can be used to form an inductive voltage divider 10 by connecting an intermediate point of contact to ground, for the electrical safety of the user.

The transformer 40, the fuse 31, the voltage divider 10 are preferably also in the housing incorporating the microcontroller 20 and the relay 6, 7.

### Example No 2

FIG. 2 illustrates an electrical power supply device 2000 for a variable light-scattering window pane of the Privalite 100 type which differs from the power supply device 1000 by the elements described hereinafter.

The counter is replaced by a clock 22′ for indicating the start and finish times of regeneration, or of forced mode or even of normal operation.

The microcontroller also comprises an interface 25′ with a CAN bidirectional communications network.

The regeneration in progress or programmed can be indicated to a server 300 connected to the communications network central 300 connected to the CAN network by a signal Si.

In the absence of a clock (variant not shown), for each regeneration, the microprocessor 21 can request to the central server 300 connected to the CAN network the start and finish times and send this data to the memory 23.

At each regeneration, or at regular intervals, or in the case of a particular event (maintenance, change of liquid crystals, etc.), the microprocessor can request, either to the central server 300 connected (in real time) to the network, or to a computer temporarily connected, that the current setpoint C and/or the duration DT be validated, or else can request/receive an update for these data.

Thus, the setpoint C and/or the duration DT can be transmitted to the microprocessor 21 over the CAN communications network via the interface 25′.

Alternatively or cumulatively, the microprocessor 21 can finally receive over the network, via the interface 25′, data useful for calculating itself the setpoint C and/or the duration DT, for example using correspondence tables or graphs.

Furthermore, the server 300 or the computer temporarily connected (maintenance PC, etc.) can read, or even download the data stored in the memory via the interface 25′.

Forced mode in progress can also be indicated to the server 300 connected to the communications network.

Furthermore, the emergency switch 6′ is replaced by another means for instigating forced mode comprising a microcontroller 20′ connected to the communications network and controlling a second relay 6″, 7″ in parallel with the first relay 6, 7.

Alternatively, these means 20′, 6″, 7″ provide a backup for the manual emergency switch. These means are, for example, used in the case of a fault in the electronics, or a fault in the control of the emergency switch 6′.

The microcontroller 20′ instigates forced mode for example when it receives this fault information from the server 300 or from the microcontroller 20.

The “external” microcontroller 20′ can be similar to the “internal” microcontroller 20, or simpler (with no memory and/or counter or clock, etc.)

The request (or even the command) for forced mode can be sent by the server 300 to the microcontroller 20′ and/or to the microcontroller 20.

For example, the server 300 holds reservation information for a space comprising the system (bedrooms, meeting room, operating theaters, etc.) implying operation of the system and the server 300 then sends a request for the regeneration in progress to be halted.

The use of forced mode can preferably lead to a new setpoint communicated by the server 300 (depending on a new reservation schedule and on availability of a bedroom, on interrupting operations, etc.).

Furthermore, the regeneration can be triggered once a contextual setpoint has been met and not a scheduling setpoint.

The device 1000 comprises for example a light sensor 50, phototransistor for example, connected to an analog-digital input 24′ of the internal microcontroller 20 for transmitting information on the natural or artificial light. Thus, the regeneration can be planned as soon as night has fallen.

The regeneration may also be triggered if several setpoints are reached, notably:
setpoint on the light,
setpoint on a particular allocated timeslot for example longer than DT.

### Example No 3

FIG. 3 illustrates an electrical power supply device 3000 for a variable light-scattering window pane of the Privalite 100 type which differs from the power supply device 2000 by the elements described hereinafter.

The main switch connected to the Internal microcontroller 20 is replaced by the main “in network” switch 30′, connected to a microcontroller 20′ which is connected to the communications network and which communicates with the microcontroller 20.

The means for controlling forced mode are replaced by an emergency “in network” switch 6″′, connected to a microcontroller 20″ connected to the communications network and which communicates with the microcontroller 20.

It goes without saying that, by extension, a device may be provided for regeneration of liquid crystals of several liquid crystal window panes each comprising a device such as described in FIGS. 1 to 3 and using the CAN communications network for the exchange of data for the regeneration carried out or to be carried out, or else on forced mode or even sharing data from sensors (for example by a sensor common to several systems and preferably on a network).

1. A method for regenerating liquid crystals of a variable light-scattering electrically controlled system comprising a substrate carrying a liquid crystal element between two electrodes connected to an electrical power supply, the method comprising:
supplying data for the regeneration comprising a regeneration duration DT and at least one regeneration setpoint C,
programming for the regeneration comprising comparing operational data with the regeneration setpoint C,
automatically regenerating by automatic power-down of the electrical circuit for the period of the duration DT, once the setpoint or setpoints C have been reached,
and programming for an Operating decision referred to as ‘forced mode’ during the regeneration in progress depending on the history of use and/or the context of use.

2. The method for regenerating liquid crystals of an electrically controlled system as claimed in claim 1, wherein at least one of the regeneration data values is sent via a communications network.

3. The method for regenerating liquid crystals of an electrically controlled system as claimed in claim 1, comprising transmitting a signal for automatically interrupting the regeneration to the electrical power supply via a communications network.

4. The method for regenerating an electrically controlled system as claimed in claim 1, comprising connecting the electrical power supply to a communications network for receiving data for the regeneration to be carried out, notably C and DT, and/or for the transmission of data on the regeneration carried out.

5. The method for regenerating an electrically controlled system as claimed in claim 4, comprising transmitting a request for forced mode via the communications network and/or transmitting a request for forced mode by direct connection with the electrical power supply.

6. The method for regenerating liquid crystals of an electrically controlled system as claimed in claim 1, comprising transmitting a request for forced mode and/or transmitting a forced mode command by actuation of a switch or switches connected to a communications network.

7. The method for regenerating liquid crystals of an electrically controlled system as claimed in claim 1, comprising providing a command for forced mode by manual command or by automatic closing of a relay connected to the power supply and controlled by digital processing means connected to a communications network.

8. The method for regenerating liquid crystals of an electrically controlled system as claimed in claim 1, wherein the interruption of the regeneration is controlled based on temporal data notably a maximum duration of use(s), a given start time or a given range of times.

9. The method for regenerating liquid crystals of an electrically controlled system as claimed in claim 1, wherein the interruption of the regeneration is controlled based on contextual data supplied by a sensor or sensors electrically connected to the electrical power supply or data supplied by a sensor or sensors and received by the electrical power supply via a communications network.

10. The method for regenerating liquid crystals of an electrically controlled system as claimed in claim 1, wherein the interruption of the regeneration is controlled for a given brightness in the absence of a detected presence and/or movement.

11. The method for regenerating an electrically controlled system as claimed in claim 1, wherein the interruption of the regeneration is engaged in the case of absence of reservation of the space including the electrically-controllable system, notably by consultation of a reservation server via a communications network.

12. The method for regenerating an electrically controlled system as claimed in claim 1, wherein the setpoint C and/or the regeneration duration DT is/are fixed as a function of the operating temperature of the electrically controlled system, measured or calculated operating temperature.

13. The method for regenerating an electrically controlled system as claimed in claim 1, comprising storing the data for the regeneration to be carried out and/or on the regeneration carried out and, where relevant, of data on forced mode, preferably within the power supply.

14. A method for managing the regeneration of liquid crystals of a plurality of electrically controlled systems each comprising a substrate carrying a liquid crystal element between two electrodes connected to an electrical power supply, the method incorporating the regeneration method as claimed in claim 1 which includes, for each of the power supplies:
supplying data for the regeneration comprising a regeneration duration DT and at least one regeneration setpoint C,
programming for the regeneration comprising comparing operational data with the regeneration setpoint C,
automatically regenerating by automatic power-down of the electrical circuit for the duration of the duration DT, once the setpoint or setpoints C have been reached,
programming for an operating decision referred to as ‘forced mode’ during the regeneration in progress depending on the history of use and/or the context of use, and
for the communication of data for the regeneration or regenerations to be carried out on the regeneration or regenerations carried out, connecting the electrical power supplies to the same communications network.

15. The method for regenerating liquid crystals of an electrically controlled system as claimed in claim 14, comprising addressing each of the electrical power supplies.

16. An electrical power supply for a variable light-scattering electrically controlled system including a substrate carrying a liquid crystal element between the first and second electrodes, comprising, for the implementation of the regeneration method as claimed in claim 1:
a first processing unit for the regeneration programming, the first processing unit being capable of receiving or calculating the setpoint C and the regeneration duration DT,
a processing unit, different or otherwise from the first processing unit, for the programming of forced mode, the processing unit being capable of receiving the request for forced mode, and
a relay or a connection to a relay for interrupting regeneration and for forced mode.

17. The electrical power supply for a variable light-scattering electrically controlled system as claimed in claim 16, comprising a micro-controller comprising:
a microprocessor forming at least the first digital processing unit, and preferably a single digital processing unit,
a counter or a clock, for the establishment and/or the compliance with the setpoint C and/or the duration DT,
preferably a non-volatile memory configured to store the setpoint C and/or the duration DT, and/or data on the regeneration carried out and/or on forced mode,
at least one digital-analog output configured to deliver an analog interrupt signal for the regeneration, or to implement forced mode during the regeneration.

18. The electrical power supply for a variable light-scattering electrically controlled system as claimed in claim 17, wherein the micro-controller comprises at least one analog-digital input connected to a sensor, which is preferably a light sensor.

19. The electrical power supply for a variable light-scattering electrically controlled system as claimed in claim 17, comprising an interface with a communications network, preferably a CAN.

20. A device for the regeneration of liquid crystals of at least one variable light-scattering electrically controlled system including a substrate carrying a liquid crystal element between first and second electrodes, the device comprising:
at least one electrical power supply as claimed in claim 17 connected to a communications network,
at least one main switch potentially connected to the communications network via a processing unit, operable by the user for normal operation or a request for forced mode in the case of interruption of the regeneration,
preferably, at least one other switch, potentially connected to the communications network via a processing unit, operable by the user for a forced mode command in the case of interruption of the regeneration, and
potentially a relay, controlled by a processing unit connected to the communications network, for a forced mode command in the case of interruption of the regeneration.
